(19) United States
(12) Patent Application Publication
(10) Pub. No.: US 2022/0309144 A1
(43) Pub. Date: Sep. 29, 2022

(54) ELECTRONIC DEVICE AND COMMUNICATION METHOD

(71) Applicant: SEIKO EPSON CORPORATION, Tokyo (JP)

(72) Inventor: Junpei KOIZUMI, Matsumoto (JP)

(21) Appl. No.: 17/655,562

(22) Filed: Mar. 21, 2022

(30) Foreign Application Priority Data
Mar. 23, 2021 (JP) 2021-048717

(51) Int. Cl. G06F 21/44

(52) U.S. Cl. CPC G06F 21/44

(57) ABSTRACT

An electronic device includes a communication unit that performs wireless communication based on Bluetooth with a terminal device and a processor that controls the communication unit. The processor determines a command received via the communication unit without performing authentication based on pairing with the terminal device, performs an authentication process when the processor determines that the command is an authentication request command, and performs a process of transmitting a NACK response to the terminal device via the communication unit when the processor determines that the command is a command other than the authentication request command.

The present application is based on, and claims priority from JP Application Serial Number 2021-048717, filed Mar. 23, 2021, the disclosure of which is hereby incorporated by reference herein in its entirety.

### BACKGROUND

### 1. Technical Field

The present disclosure relates to an electronic device, a communication method, and the like.

### 2. Related Art

According to a Bluetooth (registered trademark) standard, pairing is defined as authentication means. In the pairing, a link key that is an encryption key is generated, exchanged, and saved between a master and a slave. Saving of the link key is also called bonding. At the time of communication, encryption is performed using this link key. For example, JP-A-2019-12945 discloses Bluetooth pairing in which authentication is performed by a user inputting a PIN code.

However, pairing with an authentication operation using a pass key or the like has a problem that a user operation is complicated. There has not been proposed a technique with which an appropriate authentication process can be realized without using such pairing.

### SUMMARY

An aspect of the present disclosure relates to an electronic device including a communication unit that performs wireless communication based on Bluetooth with a terminal device; and a processing unit that controls the communication unit. The processing unit determines a command received via the communication unit without performing authentication based on pairing with the terminal device, performs an authentication process when the processing unit determines that the command is an authentication request command, and performs a process of transmitting a NACK response to the terminal device via the communication unit when the processing unit determines that the command is a command other than the authentication request command.

Another aspect of the present disclosure relates to a communication method of performing wireless communication based on Bluetooth with a terminal device by using a communication unit, the communication method including determining a command received via the communication unit without performing authentication based on Bluetooth pairing with the terminal device; performing an authentication process when the command is determined to be an authentication request command; and performing a process of transmitting a NACK response to the terminal device via the communication unit when the command is determined to be a command other than the authentication request command.

### BRIEF DESCRIPTION OF THE DRAWINGS

FIG. 1 illustrates a configuration example of an electronic device according to an embodiment.

FIG. 2 illustrates an example of a colorimeter as an example of the electronic device.

FIG. 3 is an explanatory diagram of a process according to the present embodiment.

FIG. 4 is an explanatory diagram of the process according to the present embodiment.

FIG. 5 is an explanatory diagram of the process according to the present embodiment.

FIG. 6 is an explanatory diagram of the process according to the present embodiment.

FIG. 7 is an explanatory diagram of the process according to the present embodiment.

FIG. 8 is an explanatory diagram of an authentication process by a custom protocol.

FIG. 9 is a flowchart for explaining a process example according to the present embodiment.

FIG. 10 is a flowchart for explaining the process example according to the present embodiment.

FIG. 11 is an explanatory diagram of state transition of the process according to the present embodiment.

### DESCRIPTION OF EXEMPLARY EMBODIMENTS

The present embodiment to be described below is not intended to unduly limit contents described in the claims. Furthermore, not all of configurations described according to the present embodiment necessarily have to be essential configuration requirements.

1. Electronic Device

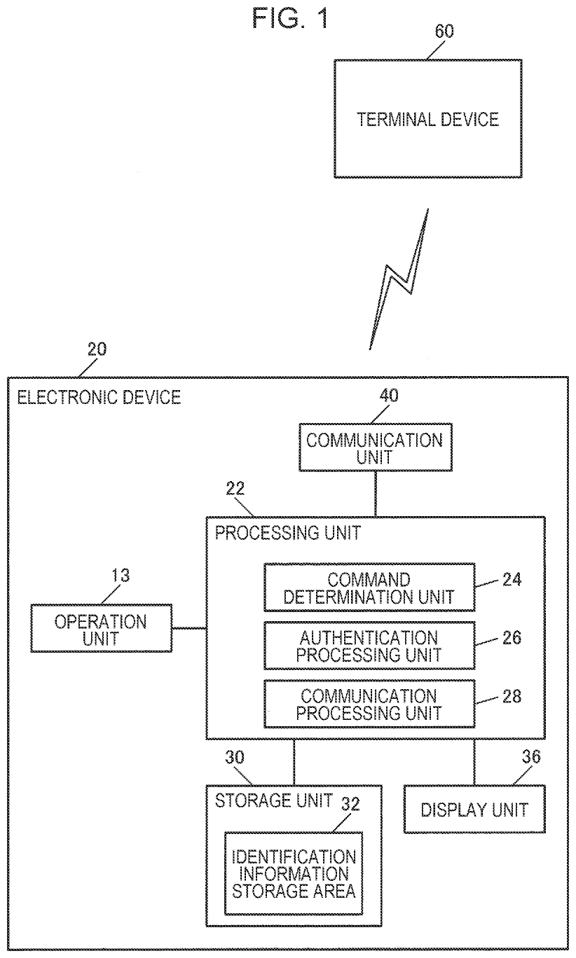

FIG. 1 is a diagram illustrating a configuration example of an electronic device 20 according to the present embodiment. The electronic device 20 includes a processing unit 22 and a communication unit 40. The electronic device 20 may further include an operation unit 13, a storage unit 30, and a display unit 36. It is noted that the electronic device 20 is not limited to the configuration illustrated in FIG. 1, and various modifications such as omission of a part of the components or addition of other components are possible.

The processing unit 22 performs a process of controlling each unit of the electronic device 20 and each process of the present embodiment. For example, the processing unit 22 performs a process of controlling the communication unit 40. In addition, the processing unit 22 performs a process of inputting operation information from the operation unit 13, a process of reading information from the storage unit 30, a process of writing information to the storage unit 30, a process of displaying information on the display unit 36, and the like. The processing unit 22 can be realized by a processor. For example, each process of the present embodiment can be realized by a processor that operates based on information such as a program and a memory that stores the information such as the program. The memory is the storage unit 30. In the processor, for example, a function of each unit may be realized by individual hardware, or the function of each unit may be realized by integrated hardware. For example, the processor may include hardware, and the hardware may include at least one of circuitry for processing digital signals and circuitry for processing analog signals. For example, the processor can be constituted by one or more circuit devices or one or more circuit elements mounted to a circuit substrate. The processor may be, for example, a central processing unit (CPU). However, the processor is not limited to the CPU, and various types of processors such as a graphics processing unit (GPU) or a digital signal processor (DSP) can be used. The processor may also be a hardware circuit by an application-specific integrated circuit (ASIC). The processor may include an amplifier circuit, a filter circuit, or the like that processes the analog signals.

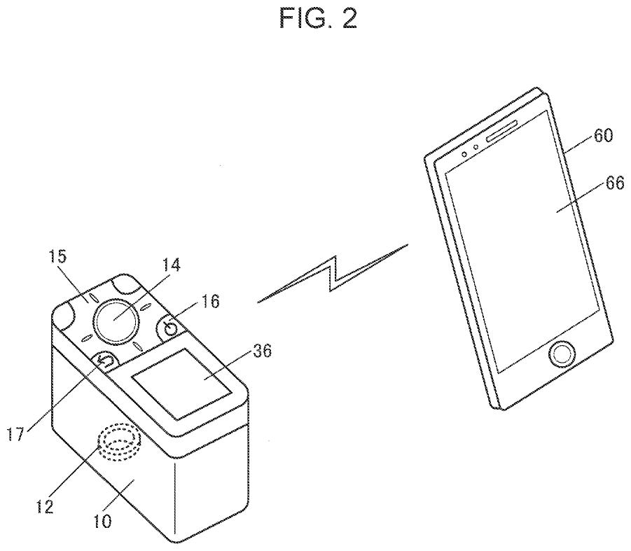

The operation unit 13 is an operation interface for inputting operation information of a user. The operation unit 13 can be realized by an operation device. When FIG. 2 described later is taken as an example, the operation unit 13 can be realized by operation devices such as a colorimetry button 14, a cross key 15, a power button 16, and a return button 17. However, an operation device that realizes the operation unit 13 is not limited to these operation devices.

The storage unit 30 stores various types of information. For example, the storage unit 30 stores programs and data. An identification information storage area 32 of the storage unit 30 stores identification information realized by, for example, a globally unique identifier (GUID). The storage unit 30 functions as, for example, a work area of the processing unit 22 and the communication unit 40. For example, the storage unit 30 which is a memory may be a semiconductor memory such as a static random-access memory (SRAM), a dynamic random-access memory (DRAM), or a nonvolatile memory, may be a register, or may be a hard disk device or the like. For example, the storage unit 30 which is a memory stores computer-readable instructions, and when the instructions are executed by the processing unit 22 which is a processor, the process of each unit of the processing unit 22 is realized. The instruction herein may be an instruction set constituting a program or an instruction for instructing a hardware circuit of a processor to perform an operation.

The display unit 36 displays various types of information for the user. The display unit 36 can be realized by various displays such as a liquid crystal display and an organic EL display. The display unit 36 displays, for example, information necessary for the user to operate the electronic device 20, various types of status information of the electronic device 20, and the like.

The communication unit 40 is a communication interface that performs wireless or wired communication with an external device such as a terminal device 60. The communication unit 40 can be realized by, for example, hardware such as a communication ASIC or a communication processor, communication firmware, or the like. According to the present embodiment, the processing unit 22 performs, on the communication unit 40, a communication control process such as a transmission process and a reception process of information, and thus the communication unit 40 transmits information to an external device and receives information from the external device. The communication unit 40 communicates with an external device such as the terminal device 60 by short-range wireless communication based on Bluetooth or the like. To be more specific, the communication unit 40 communicates with an external device by wireless communication of a Bluetooth Low Energy (BLE) standard. It is noted that as the Bluetooth standard, various versions of standards such as Ver. 4.X, Ver. 5.0, or further developed standards of these can be adopted. In addition, the communication unit 40 may communicate with an external device by wireless communication of another standard such as Wi-Fi (registered trademark). Furthermore, the communication unit 40 may perform wired communication according to a USB standard or the like.

The electronic device 20 is communicatively connected to the terminal device 60. The terminal device 60 is a communication terminal capable of performing wireless communication of information, and is realized by, for example, a smartphone or a tablet type personal computer (PC). The terminal device 60 is communicatively connected to the electronic device 20 by, for example, Bluetooth wireless communication. The terminal device 60 has a terminal display unit 66 as illustrated in FIG. 2 described later, and is also provided with an operation device such as an operation button. The terminal display unit 66 is, for example, a touch screen, and the user performs various operations by touching the terminal display unit 66 which includes the touch screen. Similarly to the electronic device 20, the terminal device 60 can include a communication unit that performs communication based on Bluetooth or the like, a terminal processing unit that performs various processes, and a terminal storage unit that stores various types of information.

As described above, the electronic device 20 according to the present embodiment includes the communication unit 40 that performs wireless communication based on Bluetooth with the terminal device 60, and the processing unit 22 that controls the communication unit 40. The processing unit 22 then determines a command received from the terminal device 60 via the communication unit 40. For example, the processing unit 22 determines the command received via the communication unit 40 without performing authentication based on pairing with the terminal device 60. A state in which the authentication based on the pairing is not performed means, for example, that generation or exchange of a link key by Bluetooth pairing is not performed, and means, for example, that communication in plain text that is not encrypted is performed. A command determination process is performed by the command determination unit 24 of the processing unit 22. When the processing unit determines that the received command is an authentication request command, the processing unit 22 performs an authentication process. For example, the processing unit 22 performs the authentication process for confirming whether the terminal device 60 with which communication connection has been established by Bluetooth is a valid connection destination device. This authentication process is performed by the authentication process unit 26 of the processing unit 22. On the other hand, when the processing unit determines that the received command is a command other than the authentication request command, the processing unit 22 performs a process of transmitting a negative acknowledgement (NACK) response to the terminal device 60 via the communication unit 40. For example, the processing unit 22 performs a process of transmitting, to the terminal device 60, the NACK response, which is a negative response transmitted from the reception side to the transmission side. For example, the processing unit 22 performs a process of transmitting, to the terminal device 60, the NACK response for notifying the terminal device 60 that the received command is not to be processed as a valid command from an authenticated device. This transmission process of the NACK response is performed by the communication processing unit 28 of the processing unit 22. It is noted that the process of transmitting information is a process in which the processing unit 22 controls the communication unit 40 to transmit the information via the communication unit 40, and the process of receiving information is a process in which the processing unit 22 controls the communication unit 40 to receive the information via the communication unit 40.

When the user selects permission of the connection with the terminal device 60, the processing unit 22 performs a process of transmitting an authentication permission response to the terminal device 60. On the other hand, the processing unit 22 performs a process of transmitting an authentication rejection response to the terminal device 60 when the user selects rejection of the connection with the terminal device 60 or when a timeout occurs. The selection of permission or rejection of the connection by the user in this case may be performed using a selection screen to be described later which is displayed on the display unit 36, may be performed by voice input, or may be performed by an operation device such as a physical operation button provided in the electronic device 20.

FIG. 2 is a diagram illustrating a colorimeter 10 as an example of the electronic device 20. The colorimeter 10 is communicatively connected to the terminal device 60 by wireless communication based on Bluetooth or the like. As illustrated in FIG. 2, the colorimeter 10 has, for example, a substantially cubic shape, and a display unit 36, a colorimetry button 14, and a cross key 15 are provided at a top surface of the colorimeter 10. A power button 16 and a return button 17 are also provided at the top surface of the colorimeter 10. A colorimetry unit 12 is provided at a bottom surface of the colorimeter 10.

The display unit 36 is realized by, for example, a liquid crystal display, an organic EL display, or the like, and displays various types of information for the user. The colorimetry button 14 is an operation device for the user to instruct the colorimeter 10 to perform colorimetry. For example, when the user presses the colorimetry button 14, the colorimeter 10 performs colorimetry using the colorimetry unit 12. The cross key 15 is an operation device for designating, for example, up, down, left, and right directions or the like. The power button 16 is a button for switching on and off the power of the colorimeter 10. The return button 17 is a button for performing a return operation which is also referred to as a back operation.

The colorimetry unit 12 is realized by a colorimetry sensor, and has a substantially circular shape in plan view, for example. For example, the colorimetry unit 12 performs colorimetry of a target color printed on a printing medium, and outputs a colorimetric value which is a colorimetry result. As the colorimetry sensor, for example, a spectroscopic sensor can be used. The spectroscopic sensor is, for example, a sensor that measures a reflectance spectrum. Specifically, the spectroscopic sensor can be realized by, for example, a light source realized by an LED or the like, an optical filter that selects and switches a wavelength of reflected light which is light obtained by reflecting light from the light source on a measurement surface, and a light reception device that measures the amount of reflected light that has passed through the optical filter. As the optical filter, an etalon or the like which is a wavelength filter utilizing multiple interference of two opposing reflecting surfaces can be used. The colorimetry sensor realizing the colorimetry unit 12 is not limited to such a spectroscopic sensor, and the colorimetry sensor may be realized by an image sensor or the like, for example.

It is noted that the electronic device 20 of the present embodiment is not limited to the colorimeter 10 as illustrated in FIG. 2. Examples of the electronic device 20 include various devices such as an image forming apparatus such as a printing apparatus or a scanner, a wearable device such as a head-mounted display, a watch, or a wrist computer, an audio device such as a music player or headphones, a biometric information measurement device that measures biometric information, a portable information terminal such as a portable game terminal, a projector, or a robot.

2. Authentication Process Based on Authentication Request Command

In Bluetooth, pairing is performed between devices. For example, pairing of a first type is pairing with no authentication operation and no user operation. The pairing of this first type has an advantage that a user operation is not necessary for a device at a connection destination, but has a disadvantage that a trouble occurs at the time of reconnection due to deletion of an encryption key in a device at a connection source or a connection destination or that an authentication function is not provided. Pairing of a second type is pairing in which an authentication operation is performed and a pass key is confirmed. In the pairing of the second type, a six-digit number is displayed in the device at the connection source, and matching confirmation of a numeric string and an operation of permission or rejection are performed in the device at the connection destination. The pairing of the second type has an advantage that there is an authentication function, but has a disadvantage that a trouble occurs at the time of the reconnection described above or that the user needs to confirm the numeric string of the pass key. Pairing of a third type is pairing in which an authentication operation is performed and a pass key input is performed. In the pairing of the third type, a six-digit number is displayed as a pass key in the device at the connection source, and a numeric string is input in the device at the connection destination. The pairing of the third type has an advantage that there is an authentication function, but has a disadvantage that a trouble occurs at the time of the reconnection described above or that the user needs to input the numeric string of the pass key.

Up to now, there has been no proposal of a method with which an authentication process that does not use Bluetooth pairing can be realized. In view of the above, the present embodiment illustrates the electronic device 20 and a communication method with which the authentication process that does not use the pairing can be realized. Specifically, in the communication method of the present embodiment, the electronic device 20 determines a command received via the communication unit 40 without performing authentication based on Bluetooth pairing with the terminal device 60. When the command is determined to be the authentication request command, the electronic device 20 performs the authentication process, and when the command is determined to be a command other than the authentication request command, the electronic device 20 performs the process of transmitting the NACK response to the terminal device 60 via the communication unit 40. In this way, when the received command is a command other than the authentication request command, the NACK response is returned, and thus it is possible to realize the authentication process that does not use the pairing.

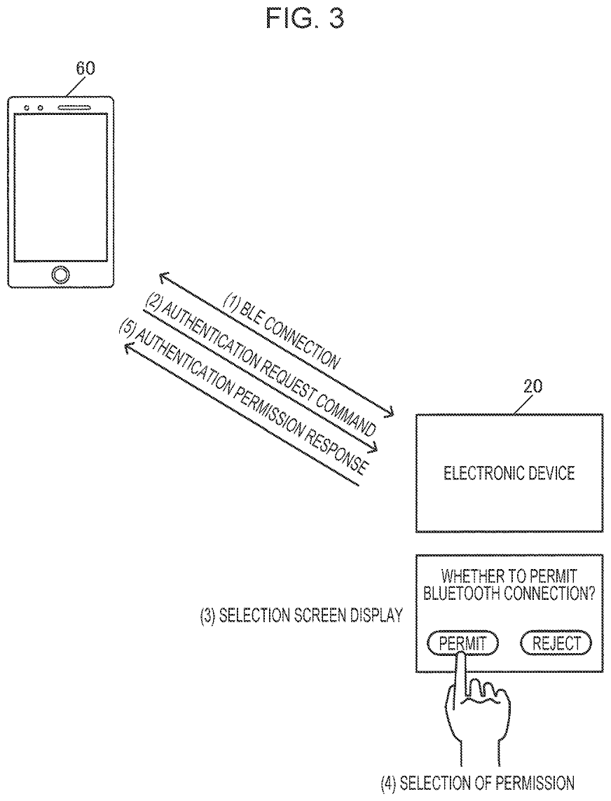

FIGS. 3, 4, 5, 6 and 7 are explanatory diagrams of the process of the present embodiment. In FIG. 3, a wireless connection by Bluetooth is first established between the electronic device 20 and the terminal device 60. This wireless connection is a Bluetooth connection in which the pairing is not performed. The Bluetooth connection in which the pairing is not performed is, for example, a connection without Level security in Bluetooth Low Energy. It is noted that according to the present embodiment, Bluetooth and Bluetooth Low Energy are appropriately referred to as BLE. After a Bluetooth connection in which the pairing is not performed is established, the terminal device 60 transmits the authentication request command, and the electronic device 20 receives this authentication request command. When it is determined that the authentication request command has been received, the electronic device 20 displays, on the display unit 36, a selection screen, for example, as illustrated in FIG. 3. The user can select whether to permit or reject the connection with the terminal device 60 on this selection screen. In FIG. 3, since the user selects permission, the electronic device 20 transmits the authentication permission response to the terminal device 60. Accordingly, even when the terminal device 60 and the electronic device 20 do not perform authentication based on the pairing, the connection between the terminal device 60 and the electronic device 20 by the authentication process of a custom protocol, for example, can be realized.

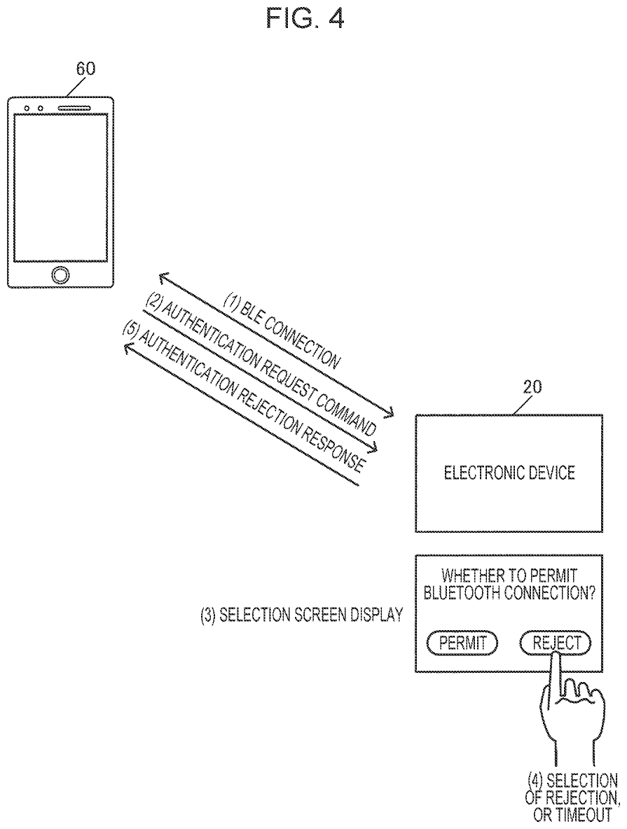

In FIG. 4, after the establishment of the Bluetooth connection in which the pairing is not performed, the authentication request command is transmitted and the selection screen is displayed on the electronic device 20, but the user selects rejection of the connection with the terminal device 60 on this selection screen. In this case, the electronic device 20 transmits the authentication rejection response to the terminal device 60. Thus, even when the authentication request command is received from the terminal device 60, the user can reject the authentication request by the user's own operation.

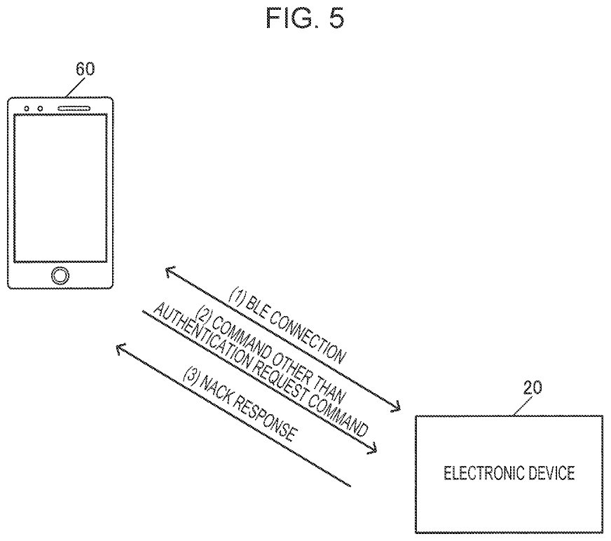

In FIG. 5, after the establishment of the Bluetooth connection in which the pairing is not performed, the terminal device 60 transmits a command other than the authentication request command before the authentication by the authentication request command succeeds. In this case, the electronic device 20 transmits the NACK response to the terminal device 60. In this way, the electronic device 20 can return the NACK response, which is a negative response, to the terminal device 60 that has transmitted the command and requested processing of the command in a state in which the authentication by the authentication request command has not succeeded. For example, the electronic device 20 can transmit, to the terminal device 60, information indicating that the command is not an approved command. In this way, an appropriate authentication process can be realized even without using the pairing.

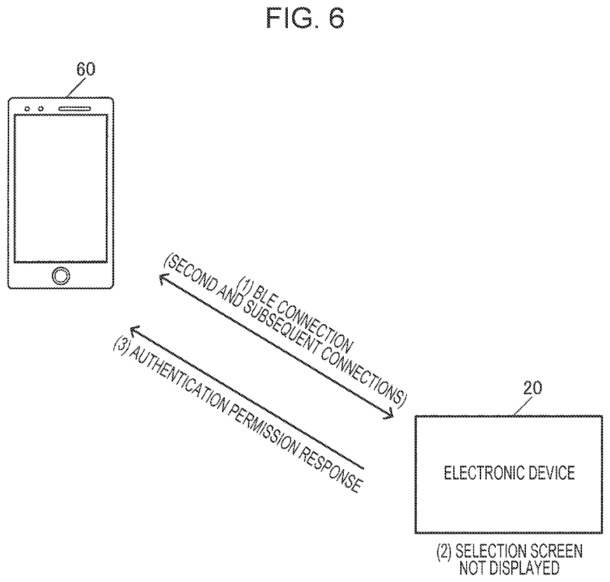

In FIG. 6, the second and subsequent Bluetooth connections are established between the electronic device 20 and the terminal device 60. That is, authentication has succeeded between the electronic device 20 and the terminal device 60 by the authentication request command in the past, and after the Bluetooth connection is disconnected, the second and subsequent Bluetooth connections are established again between the electronic device 20 and the authenticated terminal device 60. In this case, as illustrated in FIG. 6, the electronic device 20 transmits the authentication permission response to the terminal device 60 without displaying the selection screen illustrated in FIGS. 3 and 4 on the display unit 36. In this way, in the second and subsequent Bluetooth connections, the user does not need to perform a selection operation such as permission on the selection screen, and the user operation can be simplified to improve convenience for the user. Specifically, when the authentication by the authentication request command succeeds with the terminal device 60, the electronic device 20 saves the identification information of the terminal device 60 as saved identification information in the identification information storage area 32 of FIG. 1. In the second and subsequent Bluetooth connections with the terminal device 60 after the Bluetooth connection with the terminal device 60 is disconnected, the electronic device 20 determines whether or not the identification information included in the authentication request command from the terminal device 60 matches the saved identification information in the identification information storage area 32. When the identification information included in the authentication request command is determined to match the saved identification information, the electronic device 20 transmits the authentication permission response to the terminal device 60 without performing the process of displaying the selection screen on the display unit 36. As a result, the user's input operation on the selection screen can be omitted, and the convenience for the user is improved.

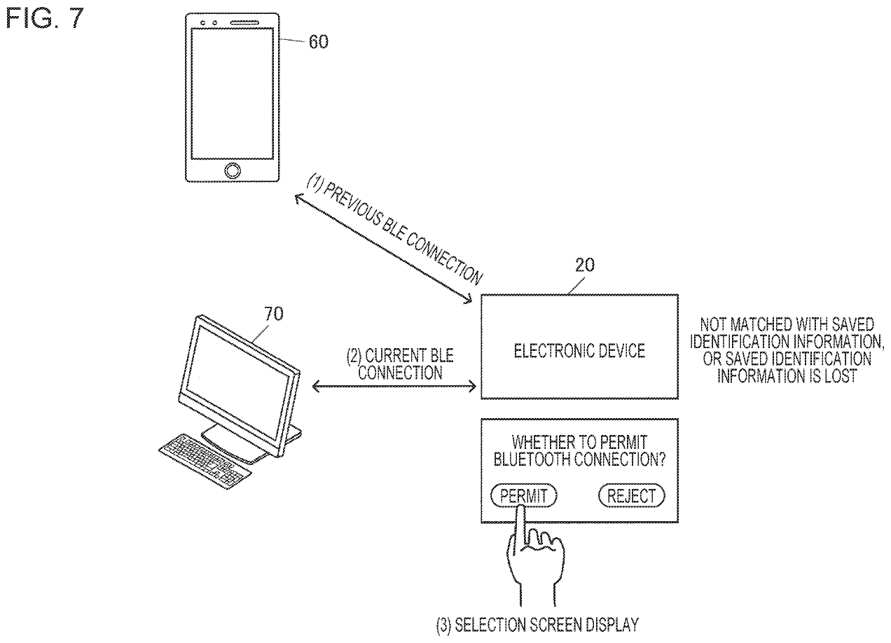

In FIG. 7, after the Bluetooth connection with the authenticated terminal device 60 is disconnected, the electronic device 20 establishes a Bluetooth connection in which the pairing is not performed with another terminal device 70. The other terminal device 70 then transmits an authentication request command, and the electronic device 20 receives this authentication request command. In FIG. 7, the disconnected Bluetooth connection between the electronic device 20 and the terminal device 60 is referred to as a previous BLE connection. In addition, in FIG. 7, the Bluetooth connection between the electronic device 20 and the other terminal device 70 is referred to as a current BLE connection. In this case, the electronic device 20 displays, on the display unit 36, the selection screen for the user to select whether or not to permit the connection with the other terminal device 70. When the user selects permission on this selection screen, the authentication permission response is transmitted to the other terminal device 70, and authentication of the other terminal device 70 is performed. Specifically, since the authentication with the terminal device 60 is successful as described above, the identification information of the terminal device 60 is saved as the saved identification information in the identification information storage area 32, but identification information of the other terminal device 70 is not saved. Therefore, the electronic device 20 determines that the authentication information included in the authentication request command from the other terminal device 70 does not match the saved identification information in the identification information storage area 32, and displays, on the display unit 36, the selection screen for performing the authentication process of the other terminal device 70. Alternatively, also when the saved identification information in the identification information storage area 32 is lost for some reason, the electronic device 20 displays, on the display unit 36, the selection screen for performing the authentication process of the other terminal device 70. With this configuration, when the identification information included in the authentication request command does not match the saved identification information or when the saved identification information is lost, the electronic device 20 can execute an appropriate authentication process for the other terminal device 70. It is noted that in a case where only one piece of saved identification information can be stored in the identification information storage area 32, when the authentication of the other terminal device 70 succeeds in FIG. 7, the authentication process using the selection screen is again necessary for the terminal device 60.

As described above, according to the present embodiment, the processing unit 22 of the electronic device 20 determines the command received via the communication unit 40 without performing the authentication based on the pairing with the terminal device 60. When the processing unit 22 determines that the command is the authentication request command as illustrated in FIG. 4, the processing unit 22 performs the authentication process. For example, the processing unit 22 performs the authentication process for the user to select whether or not to permit the connection with the terminal device 60. Specifically, the processing unit 22 displays the selection screen for authentication and performs the authentication process for the user to select whether or not to permit the connection with the terminal device 60 on the selection screen. On the other hand, when the processing unit 22 determines that the command is a command other than the authentication request command, the processing unit 22 performs the process of transmitting the NACK response to the terminal device 60 via the communication unit 40 as illustrated in FIG. 5. The NACK response is a response for informing the terminal device 60 that the command has not been approved.

As described above, according to the present embodiment, when the authentication based on Bluetooth pairing is not performed, the processing unit 22 determines the authentication request command from the terminal device 60, and the custom authentication process can thus be realized. Therefore, the complicated user operation required in the pairing with the authentication operation can be omitted, and the authentication function by the simple user operation can be realized. When the terminal device 60 transmits a command other than the authentication request command without performing such authentication process, the NACK response is transmitted to the terminal device 60. Therefore, the electronic device 20 can return the negative response, to the terminal device 60, informing the terminal device 60 that the command is not to be approved because the authentication process has not yet been completed. Therefore, the command transmitted before the authentication process is performed can be rejected as an inappropriate command without being approved. Therefore, it is possible to provide the electronic device 20 capable of realizing the appropriate authentication process without using the pairing. Furthermore, in the pairing, since a key used for encryption is generated in both devices, a trouble in reconnection due to key management may occur. For example, when the key is deleted by initialization in one of the devices, a trouble that reconnection is not to be performed occurs. In this regard, according to the present embodiment, since the custom authentication process based on the authentication request command is performed instead of the authentication based on the pairing, key generation and key management for the pairing are not necessary. Therefore, it is possible to prevent the occurrence of such a trouble at the time of reconnection.

In addition, according to the present embodiment, the electronic device 20 includes the display unit 36, and the processing unit 22 performs, as the authentication process, the process of displaying, on the display unit 36, the selection screen for the user to select whether or not to permit the connection with the terminal device 60 as illustrated in FIGS. 3 and 4. In this way, the user can select whether or not to permit the connection with the terminal device 60 on the selection screen, and the authentication function by the simple user operation using the selection screen can be realized. Herein, as an example, a permission icon for selecting permission of the connection and a rejection icon for selecting rejection of the connection are displayed on the selection screen. The user selects whether or not to permit the connection with the terminal device 60 by selecting the permission icon or the rejection icon. It is noted that the icons may be selected using an operation device such as the cross key 15 in FIG. 2, or may be selected by a touch operation using a touch screen as the display unit 36. Furthermore, a display mode of the selection screen is not limited to the display mode as illustrated in FIGS. 3 and 4, and various modifications can be made such as displaying an icon in a mode different from that illustrated in FIGS. 3 and 4, or realizing a user's selection using a mode other than the icons. Furthermore, instead of the display of the selection screen, whether or not to permit the connection may be selected by another input method such as voice input.

The processing unit 22 transmits the authentication permission response to the terminal device 60 when the user selects permission of the connection with the terminal device 60 on the selection screen as illustrated in FIG. 3. For example, when the user performs the selection operation such as selecting the permission icon on the selection screen, the processing unit 22 performs the process of transmitting the authentication permission response in which the permission is set as a result of the authentication response to the terminal device 60 via the communication unit 40. Thereafter, the processing unit 22 processes any other command transmitted by the terminal device 60. In this way, the user can select whether or not to permit the connection with the terminal device 60 that has transmitted the authentication request command, without performing an operation such as inputting the pass key or confirming the pass key. Therefore, the authentication function can be realized by the simple user operation.

When the user selects rejection of the connection with the terminal device 60 on the selection screen as illustrated in FIG. 4, the processing unit 22 performs the process of transmitting the authentication rejection response to the terminal device 60. For example, when the user performs a selection operation such as selecting the rejection icon on the selection screen, the processing unit 22 performs the process of transmitting the authentication rejection response in which the rejection is set as a result of the authentication response to the terminal device 60 via the communication unit 40. Alternatively, as will be described later, the processing unit 22 performs the process of transmitting the authentication rejection response to the terminal device 60 also when a timeout occurs. For example, when a predetermined period of time has elapsed without the selection of permission or rejection of the connection, the processing unit 22 determines that a timeout has occurred and performs the process of transmitting the authentication rejection response to the terminal device 60. With this configuration, the user can reject the authentication request from the terminal device 60 when the user does not desire the connection between the terminal device 60 and the electronic device 20, when the authentication request from the terminal device 60 is an authentication request unintended by the user, or when the authentication request is an authentication request due to an erroneous operation, for example. Therefore, it is possible to prevent a situation in which the terminal device 60 and the electronic device 20 are connected with each other against a user's intention or the like.

As illustrated in FIG. 6, in the second and subsequent Bluetooth connections with the terminal device 60, the processing unit 22 performs the process of transmitting the authentication permission response to the terminal device 60 without performing the process of displaying the selection screen. Thereafter, the processing unit 22 processes any other command transmitted by the terminal device 60. The second and subsequent Bluetooth connections in this case refer to Bluetooth connections after the disconnection of the Bluetooth connection in which the authentication permission response has been returned to the authentication request command, and the authentication process has been appropriately performed. In this way, in the second and subsequent Bluetooth connections, even when the user does not perform an operation such as the selection of permission on the selection screen, the electronic device 20 and the terminal device 60 are connected with each other since the authentication process is appropriately performed. Therefore, for example, the electronic device 20 and the terminal device 60 are automatically connected with each other in the same manner as Bluetooth reconnection after the pairing is performed, and the convenience of the user is improved.

3. Detailed Process

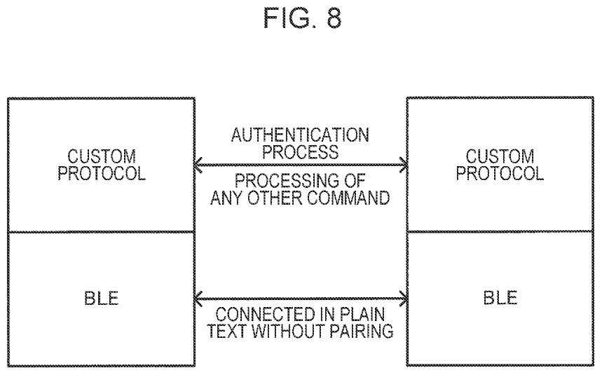

Next, a detailed process example of the present embodiment will be described. FIG. 8 is a diagram illustrating a Bluetooth protocol stack according to the present embodiment. In a physical layer, a link layer, and the like of Bluetooth, communication connection in plain text without the pairing is performed. That is, since the generation and the exchange of the key due to the pairing are not performed, encryption using a key is not performed and Bluetooth communication in plain text is performed. In a layer of the custom protocol, the authentication process based on the authentication request command as described with reference to FIGS. 3 to 7 is performed. When the terminal device 60 is successfully authenticated in the authentication process, the processing unit 22 executes a process of executing any other command. For example, in response to any other command from the terminal device 60, a process such as transmission of information of the electronic device 20 to the terminal device 60 or reception of information from the terminal device 60 by the electronic device 20 is performed. When FIG. 2 is taken as an example, such a process is performed that colorimetric data and status information of the colorimeter 10 are transmitted from the colorimeter 10 to the terminal device 60, or the colorimeter 10 receives information from the terminal device 60 for causing the colorimeter 10 to perform a predetermined operation. In this way, after the authentication of the terminal device 60 is appropriately performed by the authentication process based on the authentication request command, the electronic device 20 can execute any other command from the terminal device 60. Therefore, it is possible to execute various processes such as transmission and reception of information by processing any other command in a state in which security is ensured by the authentication process. It is noted that for information such as confidential information for which communication with high security is required, the terminal device 60 may request the pairing, for example, and encrypt the communication.

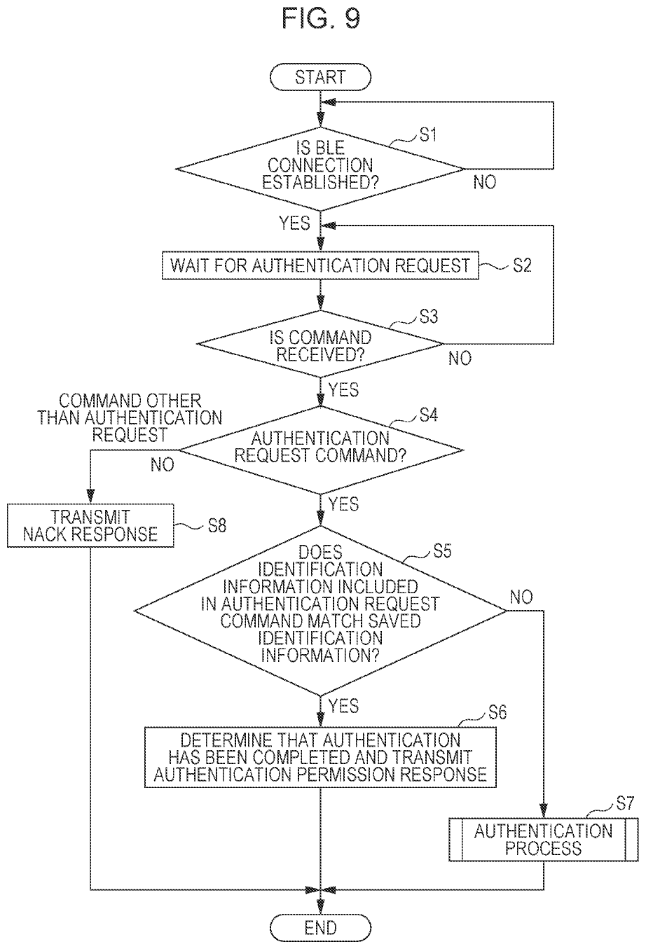

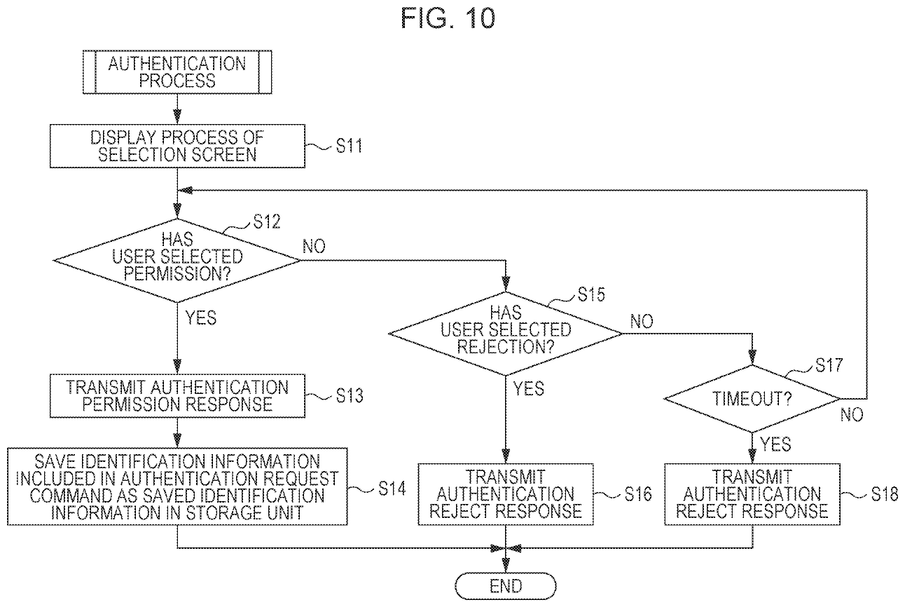

FIGS. 9 and 10 are flowcharts for explaining a detailed process example of the present embodiment. First, the processing unit 22 of the electronic device 20 determines whether or not a Bluetooth connection in which pairing is not performed is established (step S1). When the Bluetooth connection in which the pairing is not performed is established, the processing unit 22 proceeds to a waiting status for an authentication request (step S2).

Next, the processing unit 22 that has shifted to the waiting status for the authentication request determines whether or not a command is received from the terminal device 60 (step S3), and when the command is received, determines whether or not the received command is the authentication request command (step S4). When the processing unit 22 determines that the received command is the authentication request command, the processing unit 22 determines whether or not the identification information included in the authentication request command matches the saved identification information stored in the storage unit 30 (step S5). For example, when the electronic device 20 successfully authenticates the terminal device 60, identification information such as a GUID of the terminal device 60 is stored, as the saved identification information, in the identification information storage area 32 of the storage unit 30 of FIG. 1. The identification information storage area 32 is a storage area secured in a nonvolatile memory such as an electrically erasable programmable read-only memory (EEPROM) that realizes the storage unit 30, for example. Therefore, even when the power of the electronic device 20 is switched off, the saved identification information stored in the identification information storage area 32 is not lost. Therefore, the processing unit 22 can determine whether or not the authentication request command is from the authenticated terminal device 60 by reading the saved identification information stored in the identification information storage area 32 of the storage unit 30 and comparing the saved identification information with the identification information included in the authentication request command. When the processing unit 22 determines that the identification information included in the authentication request command matches the saved identification information, the processing unit 22 determines that authentication has been completed and transmits the authentication permission response to the terminal device 60 (step S6). As a result, as described with reference to FIG. 5, in the second and subsequent Bluetooth connections with the terminal device 60, the process of displaying the selection screen is not performed, and the authentication permission response is transmitted to the terminal device 60. On the other hand, when the processing unit 22 determines that the identification information included in the authentication request command does not match the saved identification information, the processing unit 22 proceeds to the authentication process described in detail with reference to FIG. 10 below (step S7). When the command received in step S4 is a command other than the authentication request command, the processing unit 22 transmits the NACK response (step S8). That is, as described with reference to FIG. 5, the processing unit 22 determines that a command received from the terminal device 60 for which authentication has not been completed is an unapproved command, and performs the process of transmitting the NACK response.

FIG. 10 is a flowchart for explaining the authentication process of step S7 in FIG. 9. In the authentication process, the processing unit 22 performs the process of displaying the selection screen (step S11). That is, the processing unit 22 performs the process of displaying the selection screen as illustrated in FIGS. 3 and 4. The processing unit 22 then determines whether or not the user has selected permission on the selection screen (step S12), and when the user has selected permission, the processing unit 22 transmits the authentication permission response to the terminal device 60 as described in FIG. 3 (step S13). Then, the identification information included in the authentication request command is stored in the storage unit 30 as the saved identification information (step S14). The identification information included in the authentication request command is, for example, the identification information such as the GUID of the terminal device 60. As a result, the authentication of the terminal device 60 succeeds, and any other command can be processed. On the other hand, when the user does not select permission in step S12, the processing unit 22 determines whether or not the user selects rejection (step S15), and when the user selects rejection, the processing unit 22 transmits the authentication rejection response to the terminal device 60 as described in FIG. 4 (step S16). As a result, the authentication of the terminal device 60 is unsuccessful, and also any other command is not processed. When the user does not select rejection in step S15, the processing unit 22 determines whether or not a timeout has occurred (step S17), and when the processing unit 22 determines that a timeout has occurred, the processing unit 22 transmits the authentication rejection response to the terminal device 60 as described with reference to FIG. 4 (step S18). For example, the processing unit 22 measures the elapse of a predetermined time, and when the processing unit 22 determines that the predetermined time has elapsed, the processing unit 22 determines that a timeout has occurred and transmits the authentication rejection response. As a result, when the user does not perform any operation for a predetermined time after the selection screen is displayed, the authentication rejection response is transmitted to the terminal device 60, and therefore authentication is unsuccessful, and also any other command is not processed.

As described above, the electronic device 20 of the present embodiment includes the storage unit 30 that stores information, and the authentication request command includes identification information of the terminal device 60. It is noted that according to the present embodiment, an example of a case where the GUID is used as the identification information will be described, but the identification information is not limited to the GUID, and various types of information that can uniquely identify the terminal device 60 can be adopted. When the saved identification information stored in the storage unit 30 matches the identification information included in the authentication request command, the processing unit 22 performs the process of transmitting the authentication permission response without performing the process of displaying the selection screen. For example, when the authentication of the terminal device 60 is successful in the first wireless communication, as illustrated in step S14 of FIG. 10, the identification information included in the authentication request command is stored in the storage unit 30 as the saved identification information. Then, as illustrated in step S5 of FIG. 9, the processing unit 22 determines, in the second and subsequent wireless communications, whether or not the identification information included in the authentication request command matches the saved identification information stored in the storage unit 30 realized by a nonvolatile memory, and transmits the authentication permission response without performing the process of displaying the selection screen when the identification information matches the saved identification information. That is, when the identification information matches the saved identification information, the flow does not proceed to the authentication process of step S7 in FIG. 9, and the process of displaying the selection screen of step S11 in FIG. 10 is also not performed, and thus the authentication permission response is transmitted without performing the process of displaying the selection screen. In this way, for example, in the second and subsequent wireless communications, the processing unit 22 determines whether or not the identification information included in the authentication request command matches the saved identification information saved in the electronic device 20, and when they match with each other, the selection screen as illustrated in FIGS. 3 and 4 is not displayed, and it is possible to shift to an authenticated state. Therefore, in the second and subsequent wireless communications, the user does not need to select permission or rejection on the selection screen, and thus the user convenience can be improved.

When the identification information included in the authentication request command does not match the saved identification information or when the saved identification information is lost, the processing unit 22 performs the process of displaying the selection screen. In this way, the processing unit 22 determines whether or not the identification information included in the authentication request command matches the saved identification information, and displays the selection screen when the identification information does not match the saved identification information for the user to select whether or not to permit the connection with the terminal device 60, thereby enabling the execution of the authentication process with the terminal device 60. Herein, several cases are conceivable in which the selection screen is to be displayed. For example, the first case is a case where the authentication process with the terminal device 60 has not been completed and the identification information is not stored as the saved identification information in the storage unit 30. In this case, the authentication process with the terminal device 60 is realized by displaying the selection screen for the user to select whether or not to permit the connection with the terminal device 60. The second case is a case where, as illustrated in FIG. 7, a connection request is received from another terminal device 70 for which the authentication process has not been completed and which is different from the terminal device 60 for which the authentication process has been completed. In this case, the identification information of the terminal device 60 has been stored as the saved identification information in the storage unit 30, but the identification information of the other terminal devices 70 has not been stored as the saved identification information in the storage unit 30, and thus the processing unit 22 displays the selection screen for the user to select whether or not to permit the connection. The third case is a case where the saved identification information stored in the storage unit 30 is lost. For example, the authentication with the terminal device 60 is successful and the identification information of the terminal device 60 is stored as the saved identification information in the storage unit 30, but this saved identification information may be lost due to some accident. In this case also, the processing unit 22 displays the selection screen for the user to select whether or not to permit the connection.

It is noted that a configuration may be adopted in which two or more pieces of saved identification information can be stored in the storage unit 30. In this way, in the case of the connection with the other terminal device 70 after the connection with the terminal device 60 as illustrated in FIG. 7, when the authentication for the other terminal device 70 has been completed before and the identification information of the other terminal device 70 is stored as the saved identification information, the connection with the terminal device 70 can be permitted without displaying the selection screen. In a case where a plurality of pieces of saved identification information are stored in the storage unit 30 as described above, when the identification information included in the authentication request command matches any of the plurality of pieces of saved identification information, the authentication permission response may be transmitted to permit the connection, and when the identification information does not match any of the plurality of pieces of saved identification information, the selection screen may be displayed for the user to select whether or not to permit the connection.

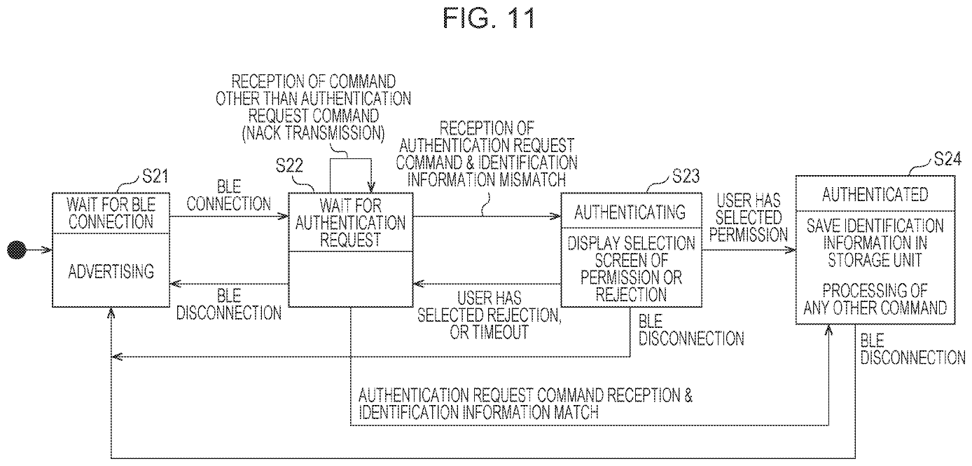

FIG. 11 is a diagram illustrating state transition of the process of the present embodiment. A state S21 is a state waiting for a Bluetooth connection, and for example, the electronic device 20 transmits an advertising packet. When the Bluetooth connection is then established, the electronic device 20 proceeds to a state 22 waiting for authentication request. This Bluetooth connection is a connection in which the pairing is not performed. In the state S22 waiting for authentication request, as described with reference to FIG. 5, the electronic device 20 transmits the NACK response when a command other than the authentication request command is received.

In the state S22 waiting for the authentication request, when the authentication request command is received and the identification information included in the authentication request command does not match the saved identification information, the electronic device 20 proceeds to an authenticating state S23. In the authenticating state S23, as illustrated in FIGS. 3 and 4, the electronic device 20 displays the selection screen to select permission or rejection. In the authenticating state S23, when the user selects permission of the connection on the selection screen, the electronic device 20 proceeds to an authenticated state S24. In addition, in the state S22 waiting for the authentication request, when the authentication request command is received and the identification information included in the authentication request command matches the saved identification information, the electronic device 20 proceeds to the authenticated state S24.

In the authenticated state S24, the electronic device 20 stores the identification information as the saved identification information in the storage unit 30 and processes any other command. That is, when a command other than the authentication request command is received from the terminal device 60, the electronic device 20 executes the command and performs a process corresponding to the command. Herein, in the authenticated state S24, the identification information is stored in the storage unit 30 only when the user selects permission and the flow proceeds to the authenticated state S24, and when the flow proceeds to the authenticated state S24 due to matching of the identification information, the electronic device 20 does not save the identification information.

In any of the cases of the state S22 waiting for the authentication request, the authenticating state S23, and the authenticated state S24, when the Bluetooth connection is disconnected, the electronic device 20 returns to the state S21 waiting for the Bluetooth connection.

It is noted that the case has been described above where the electronic device 20 displays the selection screen on the display unit 36 for the user to select permission or rejection of the connection on the selection screen, but the present embodiment is not limited to this. For example, the user may select permission or rejection of the connection by voice input, or the user may operate an operation device such as an operation button provided in the electronic device 20 to select permission or rejection of the connection. When the user selects permission of the connection with the terminal device 60, the processing unit 22 performs the process of transmitting the authentication permission response to the terminal device 60. On the other hand, the processing unit 22 performs the process of transmitting the authentication rejection response to the terminal device 60 when the user selects rejection of the connection with the terminal device 60 or when a timeout occurs. In this manner, it is possible to provide the electronic device 20 or the like capable of realizing the authentication function by the simple user operation or the like.

As described above, the electronic device of the present embodiment includes a communication unit that performs wireless communication based on Bluetooth with a terminal device, and a processing unit that controls the communication unit. The processing unit determines a command received via the communication unit without performing authentication based on pairing with the terminal device, and performs an authentication process when the processing unit determines that the command is an authentication request command. On the other hand, when the processing unit determines that the command is a command other than the authentication request command, the processing unit performs a process of transmitting a NACK response to the terminal device via the communication unit.

According to the present embodiment, in wireless communication based on Bluetooth in which the authentication based on the pairing is not performed, the authentication process can be realized by determining the authentication request command from the terminal device. When the authentication process is not performed and the terminal device transmits a command other than the authentication request command, the NACK response is transmitted, and therefore a negative response to the command can be returned to the terminal device, and an appropriate authentication process can be realized. Therefore, it is possible to provide the electronic device or the like capable of realizing the authentication process that does not use the authentication based on the pairing.

In addition, according to the present embodiment, a display unit may be included, and the processing unit may perform, as the authentication process, a process of displaying, on the display unit, a selection screen for the user to select whether or not to permit the connection with the terminal device.

According to this configuration, the user can select whether or not to permit the connection with the terminal device by using the selection screen, and the authentication function by the simple user operation using the selection screen in which the pass key is not to be checked can be realized.

In addition, according to the present embodiment, the processing unit may perform the process of transmitting the authentication permission response to the terminal device when the user selects permission of the connection with the terminal device on the selection screen.

In this way, the user can select permission of the connection with the terminal device that has transmitted the authentication request command without performing a complicated operation.

Furthermore, according to the present embodiment, the processing unit may perform the process of transmitting the authentication rejection response to the terminal device when the user selects rejection of the connection with the terminal device on the selection screen or when a timeout occurs.

With this configuration, it is possible to reject the authentication request from the terminal device when the user does not desire connection between the terminal device and the electronic device, when the authentication request from the terminal device is an authentication request that is not intended by the user, or when the authentication request is an authentication request due to an erroneous operation, for example.

Furthermore, according to the present embodiment, the processing unit may perform the process of transmitting the authentication permission response to the terminal device without performing the process of displaying the selection screen in the wireless communication with the terminal device for a second and subsequent times.

With this configuration, in the second and subsequent wireless communications, even when the user does not perform the operation such as the selection of permission on the selection screen, the electronic device and the terminal device are connected with each other since it is regarded that the authentication process is appropriately performed.

In addition, according to the present embodiment, a storage unit that stores information may be included, and the authentication request command may include identification information of the terminal device. When the identification information included in the authentication request command matches saved identification information saved in the storage unit, the processing unit may perform the process of transmitting the authentication permission response to the terminal device without performing the process of displaying the selection screen.

In this way, in the second and subsequent wireless communications, the user does not need to select permission or rejection on the selection screen, and thus the convenience for the user can be improved.

Furthermore, according to the present embodiment, the processing unit may perform the process of displaying the selection screen when the identification information included in the authentication request command does not match the saved identification information or when the saved identification information is lost.

According to this configuration, the processing unit determines whether or not the identification information included in the authentication request command matches the saved identification information, displays the selection screen, when the identification information does not match the saved identification information, for the user to select whether or not to permit the connection with the terminal device, thereby enabling execution of the authentication process with the terminal device.

In addition, according to the present embodiment, the processing unit may perform the execution process of any other command when the authentication of the terminal device is successful in the authentication process.

In this way, in a state in which security by the authentication process is ensured, any other command is processed, and various processes by any other command can be executed.

In addition, according to the present embodiment, the processing unit may perform the process of transmitting the authentication permission response to the terminal device when the user selects permission of the connection with the terminal device, and may perform the process of transmitting the authentication rejection response to the terminal device when the user selects rejection of the connection with the terminal device, or when a timeout occurs.

With this configuration, the user can select permission of the connection with the terminal device that has transmitted the authentication request command without performing the complicated operation. In addition, when the user does not desire connection between the terminal device and the electronic device, or when the authentication request from the terminal device is an authentication request that is not intended by the user or an authentication request due to an erroneous operation, for example, it is possible to reject the authentication request from the terminal device.

Furthermore, a communication method according to the present embodiment is a communication method of performing wireless communication based on Bluetooth with a terminal device by using a communication unit, in which a command received via the communication unit is determined without performing authentication based on Bluetooth pairing with the terminal device, and the authentication process is performed when the command is determined to be the authentication request command. When the command is determined to be a command other than the authentication request command, the process of transmitting a NACK response to the terminal device via the communication unit is performed.

In this way, it is possible to provide the communication method with which the appropriate authentication process can be realized without using the Bluetooth pairing.

Although the present embodiment has been described in detail above, it will be easily understood by those skilled in the art that various modifications can be made without substantially departing from the novel matters and effects of the present embodiment. Accordingly, all such modifications are intended to be included within the scope of the present disclosure. For example, in the specification or the drawings, a term described together with a different term having a broader meaning or the same meaning at least once can be replaced with the different term in any part of the specification or the drawings. In addition, all combinations of the present embodiment and the modification examples are also included in the scope of the present disclosure. Furthermore, the configurations, operations, and the like of the electronic device, the terminal device, and other devices are not limited to those described according to the present embodiment, and various modifications can be made.

What is claimed is:

1. An electronic device comprising:
a communication unit that performs wireless communication based on Bluetooth with a terminal device; and
a processor that controls the communication unit, wherein
the processor determines a command received via the communication unit without performing authentication based on pairing with the terminal device, performs an authentication process when the processor determines that the command is an authentication request command, and performs a process of transmitting a NACK response to the terminal device via the communication unit when the processor determines that the command is a command other than the authentication request command.

2. The electronic device according to claim 1, further comprising:
a display, wherein
the processor performs, as the authentication process, a process of displaying, on the display, a selection screen for a user to select whether or not to permit connection with the terminal device.

3. The electronic device according to claim 2, wherein
the processor performs a process of transmitting an authentication permission response to the terminal device when the user selects permission of the connection with the terminal device on the selection screen.

4. The electronic device according to claim 3, wherein
the processor performs a process of transmitting an authentication rejection response to the terminal device when the user selects rejection of the connection with the terminal device on the selection screen or when a timeout occurs.

5. The electronic device according to claim 3, wherein
the processor performs the process of transmitting the authentication permission response to the terminal device without performing the process of displaying the selection screen in the wireless communication with the terminal device for a second and subsequent times.

6. The electronic device according to claim 3, further comprising:
a storage that stores information, wherein
the authentication request command includes identification information of the terminal device, and
the processor performs, when the identification information included in the authentication request command matches saved identification information saved in the storage, the process of transmitting the authentication permission response to the terminal device without performing the process of displaying the selection screen.

7. The electronic device according to claim 6, wherein
the processor performs the process of displaying the selection screen when the identification information included in the authentication request command does not match the saved identification information or when the saved identification information is lost.

8. The electronic device according to claim 1, wherein
the processor performs an execution process of any other command when the terminal device is successfully authenticated in the authentication process.

9. The electronic device according to claim 1, wherein
the processor performs a process of transmitting an authentication permission response to the terminal device when a user selects permission of connection with the terminal device, and performs a process of transmitting an authentication rejection response to the terminal device when the user selects rejection of the connection with the terminal device or when a timeout occurs.

10. A communication method of performing wireless communication based on Bluetooth with a terminal device by using a communication unit, the communication method comprising:
determining a command received via the communication unit without performing authentication based on Bluetooth pairing with the terminal device;
performing an authentication process when the command is determined to be an authentication request command; and
performing a process of transmitting a NACK response to the terminal device via the communication unit when the command is determined to be a command other than the authentication request command.
